(19) United States
(12) Patent Application Publication
(10) Pub. No.: US 2004/0244558 A1
(43) Pub. Date: Dec. 9, 2004

(54) Vibration dampener for a circular saw blade

(76) Inventors: Jeremy A. Lowder, Boone, NC (US); Tammy E. Dollar, West Jefferson, NC (US); Russ Cook, West Jefferson, NC (US)

Correspondence Address: SAND & SEBOLT, AEGIS TOWER, SUITE 1100, 4940 MUNSON STREET, NW, CANTON, OH, 44718-3615, US

(21) Appl. No.: 10/456,231

(22) Filed: Jun. 5, 2003

(51) Int. Cl. B26D 1/18; B26D 1/00; B27B 3/28; B27B 27/04

(52) U.S. Cl. 83/665; 83/477.2; 83/835

(57) ABSTRACT

A vibration dampener for a circular saw blade includes a concave, disc-shaped dampening plate having a recessed area within the concavity and an annular shock absorber seated in the recessed area and projecting outwardly from the dampening plate. The dampening plate and shock absorber each abut a side of the saw blade, the abutment of the dampening plate being adjacent its perimeter. The dampener is radially weight-balanced about a transverse axis around which the dampener and blade rotate.

### BACKGROUND OF THE INVENTION

1. Technical Field

The invention relates generally to a circular saw blades. More particularly, the invention relates to a vibration dampener used in combination with circular saw blades used in woodworking. Specifically, the invention relates to a vibration dampener that is disposed adjacent to and in contact with a saw blade with the dampener disposed radially inwardly of the cutting area of the blade.

2. Background Information

Circular saw blades have been known in the art for many years. Such blades are generally used in table saws or portable saws and are generally mounted against the shoulder of a threaded arbor and held with a washer and nut. Wood workers use such blades to substantially expedite the cutting of boards while also increasing the accuracy of the cut.

A problem still remaining with the use of these saw blades is the vibration inherent in their use. Such vibrations are created by the saw motor, pulleys, the arbor, unbalanced blades, and blade interaction with the work piece. These vibrations resonate to the blade's perimeter and cause the rim of the blade to vibrate and flutter. Vibrations, or wobbling, can be described as occurring transverse to the plane of the saw blade (deflection) or radially inward and outward with respect to the axis defined by the arbor to which the blade is attached (being off center). The present invention primarily addresses the deflection problem.

The prior art includes such devices as described in U.S. Pat. No. 4,854,207 granted to Kirbach, et al., wherein guide units are mounted on the opposite sides of a circular saw blade and each guide unit includes a guide block which is capable of applying pressure to the blade as it spins to prevent vibrations. In such a configuration, the guide blocks do not rotate with the blade itself and require an independent mounting arrangement.

U.S. patent application Publication No. 2002/0081957 A1, dated Jun. 27, 2002, describes a sandpaper disc attached by adhesive to a circular saw blade. The sandpaper disc is configured to sand the sides of the cut, as well as dampening the vibrations of the saw blade. The ability to dampen such vibrations is related to the contact of the sandpaper disc with the board or other item being cut.

U.S. patent application Publication No. 2001/0037576 A1, dated Nov. 8, 2001, discloses a gear head configured for using rotary cutting tools at a remote distance via a cylindrical splined shaft which translates rotational motion to the cutting tool. This invention indicates that when a circular saw blade is used, it is clamped in between a pressure plate 16 on one side of the blade and an abutment plate 6 and a protective disc 22 on the other side.

### BRIEF SUMMARY OF THE INVENTION

The dampener of the present invention provides a dampening plate having a first side and at least one shock absorber projecting outwardly from the side of the dampening plate.

The dampener of the present invention also provides a dampening plate having a first side with at least a portion of the first side adapted to be disposed in abutment to one side of a saw blade; the dampening plate having a transverse axis about which the plate is substantially radially weight-balanced.

The dampener of the present invention further provides a dampening plate having a first side at least a portion of the which is adapted to be disposed in abutment to one side of the saw blade; and at least one shock absorber adapted to be disposed between and abutting each of the saw blade and the dampening plate.

The present invention further provides a saw comprising a frame having a work surface; a circular saw blade rotatably connected to the frame, a portion of the saw blade extending above the work surface; a drive mechanism to rotate the saw blade; a dampener abutting and coaxially rotatable with the saw blade; and the dampener disposed below the work surface.

### BRIEF DESCRIPTION OF THE DRAWINGS

A preferred embodiment of the invention, illustrative of the best mode in which applicant has contemplated applying the principles, is set forth in the following description and is shown in the drawings and is particularly and distinctly pointed out and set forth in the appended claims.

FIG. 1 is a sectional view of a prior art circular saw blade attached to an arbor without the dampener showing typical vibrations in phantom lines;

FIG. 2 is a perspective view of a typical table saw having a circular saw blade with which the dampener of the present invention would be used;

FIG. 3 is an exploded perspective view of the dampener along with the circular saw blade, the arbor to which the blade and dampener would be attached and the nut and bolt as a means of attachment;

FIG. 4 is a perspective view of the dampener as attached to an arbor adjacent a saw blade;

FIG. 5 is a sectional view taken on line 5-5 of FIG. 4; and

FIG. 6 is an enlarged view of the encircled portion of FIG. 5.

Similar numerals refer to similar parts throughout the specification.

### DETAILED DESCRIPTION OF THE INVENTION

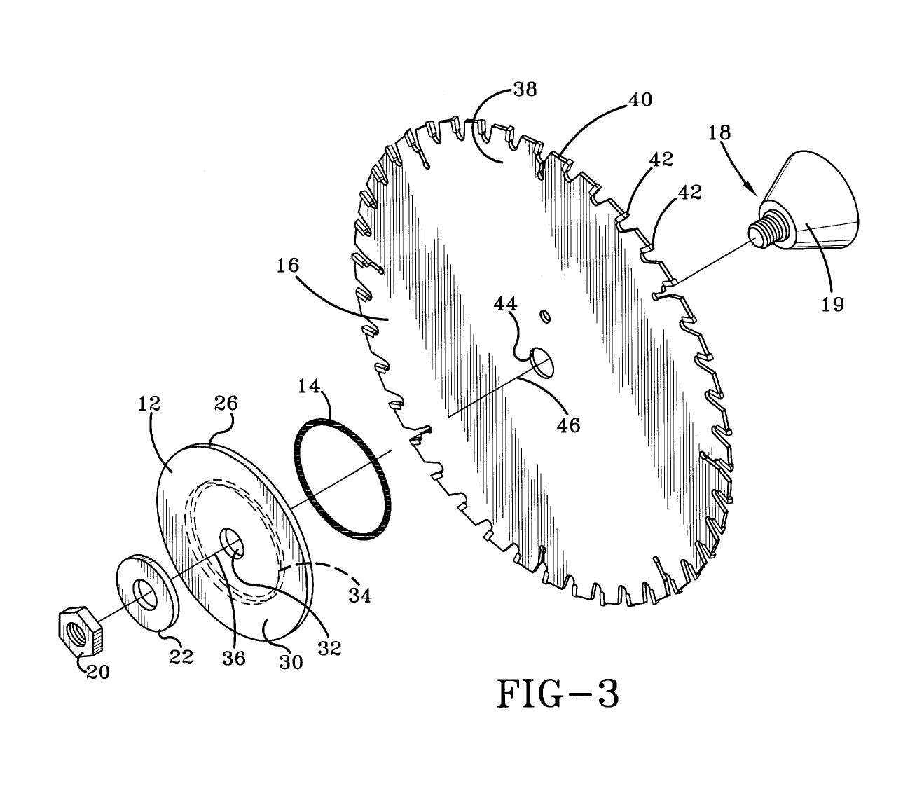

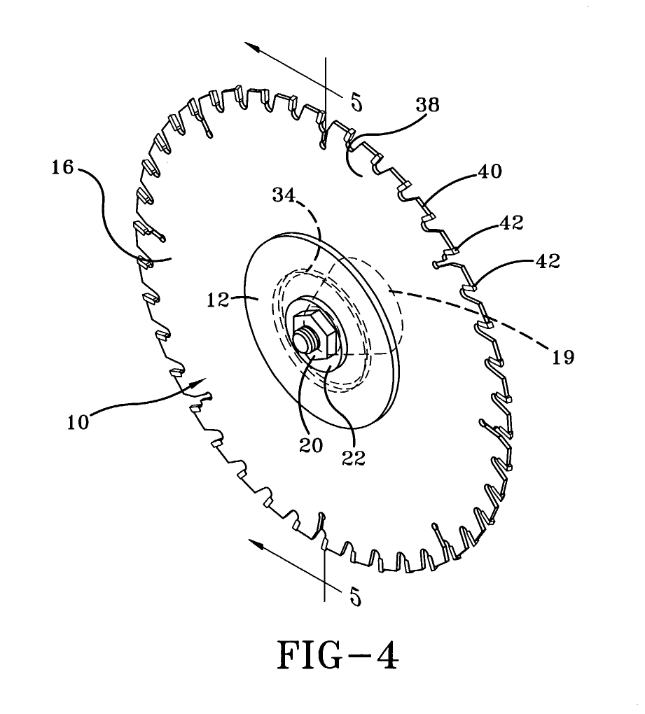

The improved vibration dampener of the present invention is indicated generally at 10 and is shown in FIGS. 3-6. Dampener 10 includes dampening plate 12 and also includes a shock absorber, such as shock absorbing ring 14 (FIG. 3). Dampener 10 is used in conjunction with circular saw blade 16, both of which would be connected to arbor 18 against shoulder 19 thereof by nut 20 with washer 22 being disposed between dampening ring 12 and nut 20. Dampener 10 would be typically used with saw blade 16 mounted on a table saw 24 having a work surface 25 and a drive mechanism 27 to rotate saw blade 16.

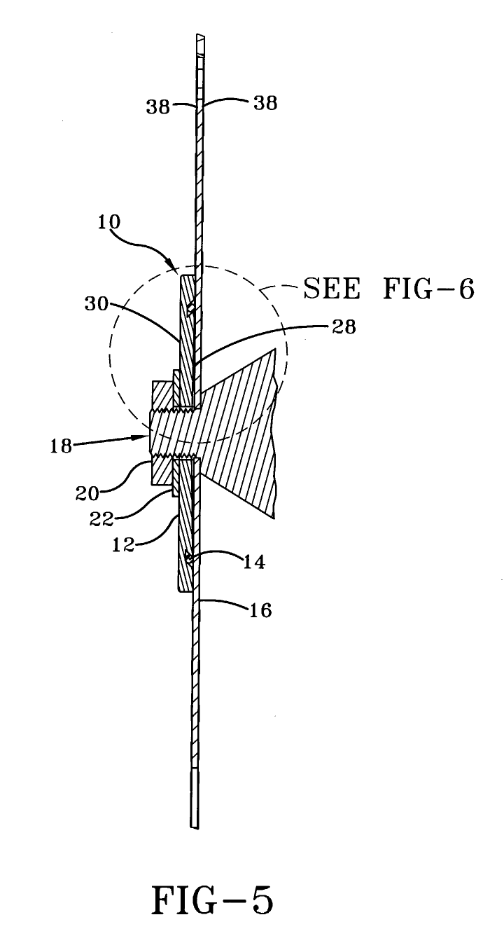

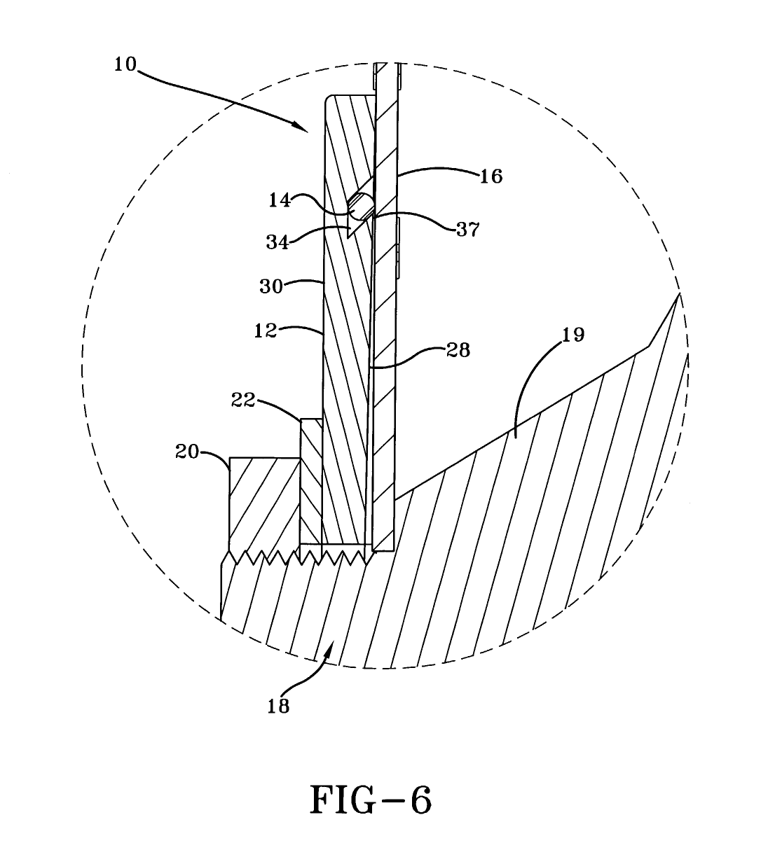

Dampening plate 10 is a circular disc having a perimeter 26, concave side 28 (FIGS. 5-6) and a convex side 30 opposite concave side 28. Dampening ring 12 further defines a central circular hole 32 and an annular recessed area 34 extending inwardly from side 28 and being concentric with hole 32 about a central axis 36. Recessed area 34 is also angled inwardly from perimeter 26 and toward axis 36, and is thus partially superimposed by an overhanging lip 37 (FIG. 6). Dampening plate 12 is preferably made from metal and is weight-balanced radially about axis 36 for use with relatively high speeds involved with the use of a circular saw blade.

Shock absorbing ring 14 is an O-ring preferably formed of an elastomeric material. Ring 14 is removably seated in recessed area 34. Ring 14 is preferably held in recessed area 34 by an interference fit, meaning that ring 14 must be deformed in some way in order for ring 14 to be inserted into recessed area 34 or a recessed area with a different configuration. In one example, ring 14 is seated in recessed area 34 and held in place by a stretch-fit wherein ring 14 stretched outwardly to fit over lip 37 and then allowed to return to a smaller diameter within recessed area 34. The removable mount may also be accomplished by having a recessed area which is not angled inwardly and wherein ring 14 is press-fit into a recessed area. Ring 14 is partially disposed within recessed area 34 and projects outwardly from concave side 28 of plate 12.

Saw blade 16 has a pair of sides 38 and a perimeter 40 with cutting teeth 42 formed around perimeter 40. Blade 16 further defines a central hole 44 concentric about a central axis 46 which is coaxial with axis 36 of dampening plate 12 when dampening plate 12 and saw blade 16 are installed on arbor 18.

As noted above, dampening plate 12 is radially weight balanced about axis 36, and therefore also about axis 46 of saw blade 16 when dampener 10 and saw blade 16 are installed on arbor 18. Preferably, the ratio of the weight of dampening plate 12 to the weight of saw blade 16 has a range of 1:4 to 1:1. Preferably, dampening plate 12 has a weight in the range of 0.4 to 1.0 pounds. Dampening plate 12 and saw blade 16 have respective diameters, and the ratio of the diameter of the dampening plate to the diameter of the saw blade preferably has a range of 1:4 to 1:2. The diameter of dampening plate 12 preferably has a range of 3 to 5 inches. Dampening plate 12 has a thickness defined between each of its sides and saw blade 16 has a thickness defined between each of its sides. The ratio of the thickness of the dampening plate to the thickness of the saw blade is preferably in the range of 4.5:1 to 1.7:1. Dampener 12 has a thickness preferably in the range of 0.100 to 0.375 inches. A specific example is a dampening plate 12 for use with a 10-inch diameter blade, which weighs 0.541 pounds and has a thickness of 0.210 inches.

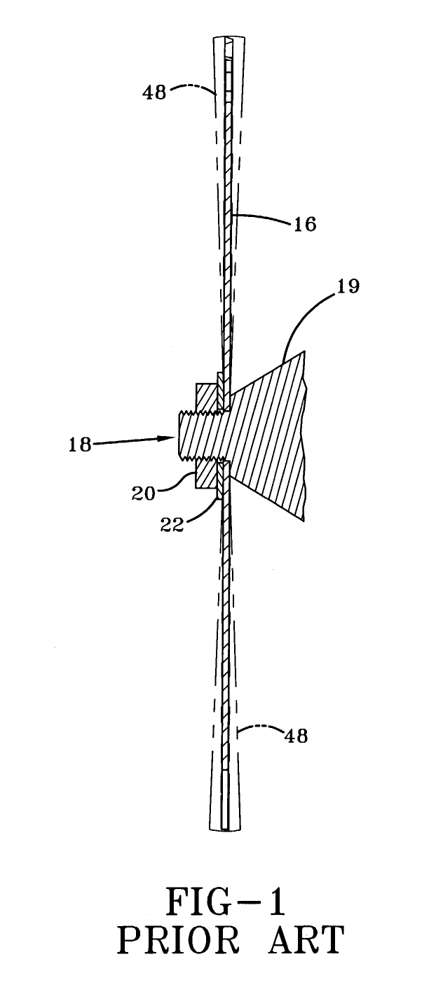

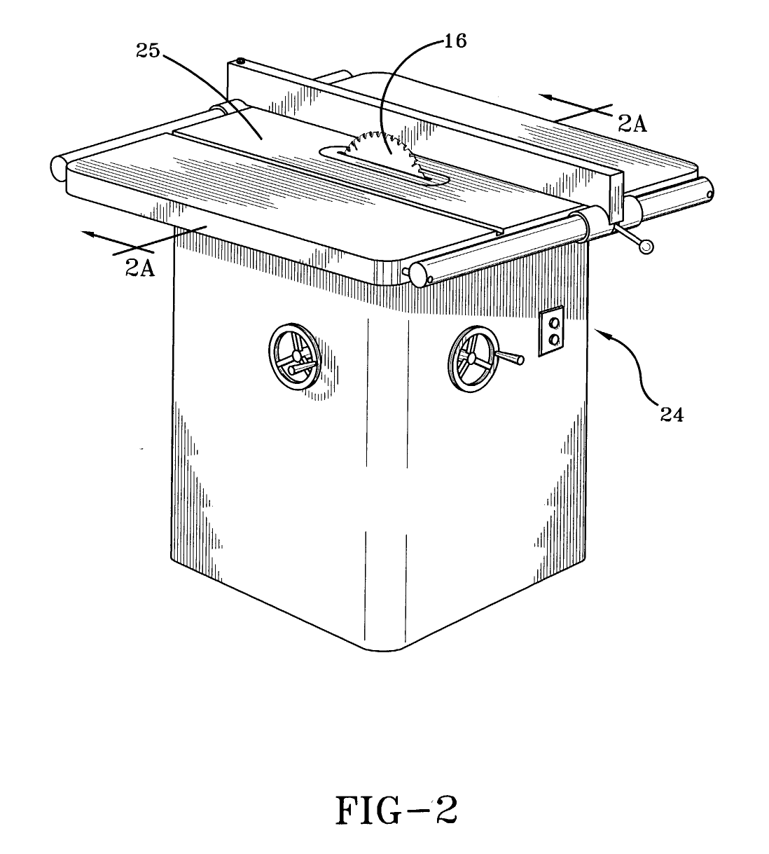

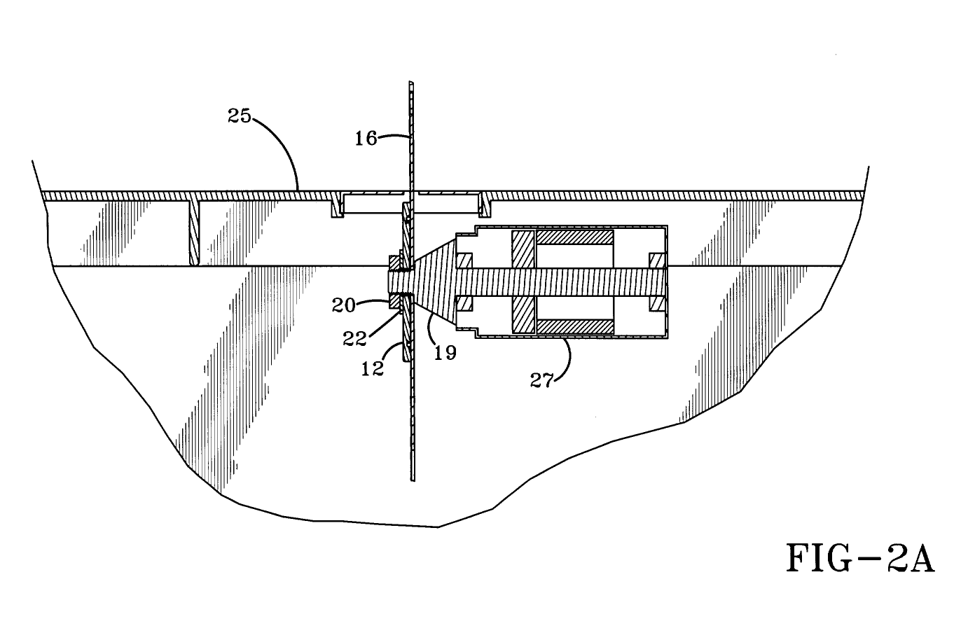

In operation, dampener 10 is installed adjacent one side of saw blade 16, both of which are installed on arbor 18 and held in place by nut 20 with washer 22 disposed between dampening plate 12 and nut 20. Dampening plate 12 abuts one side 38 of saw blade 16 adjacent perimeter 26 of dampening plate 12. Shock absorbing ring likewise abuts the same side 38 of saw blade 16 when installed. The concavity defined by concave side 28 of dampening plate 12 creates a spring bias force when nut 20 is tightened, thereby holding dampening plate 12 adjacent perimeter 26 thereof in firm abutment to blade 16. This bias also presses ring 14 against blade 16. Dampening plate 12 has a rigidity which, in combination with its abutment to blade 16, reduces the vibrations of blade 16 transverse to the plane of blade 16. The deflective movement for a saw blade not using dampener 10 caused by such vibrations is indicated in phantom lines at numeral 48 in FIG. 1, as would be far more prevalent than with a saw blade using dampener 10. Clearly, the respective diameter of dampening plate 12 in relation to the diameter of blade 16 is related to reducing such vibrations. The larger the respective diameter of dampening plate 12 to that of blade 16, the greater the reduction of the vibrations. As a practical matter, however, dampener 12 has a diameter limited such that a substantial cutting depth is maintained for blade 16 without dampening plate 12 interfering therewith. In addition, limiting the diameter of dampening plate 12 is intended to prevent interference with table saw 24 to which blade 16 is attached. In use with table saw 24, no portion of dampener 10 extends above work surface 25, thus preventing interference of dampener 10 with a work piece being cut. Similarly, the relative weight of dampening plate 12 to the weight of saw blade 16 is set to provide the greatest amount of vibration reduction while using the smallest weight of dampening plate 12, although this range obviously varies as noted above. Likewise, the ratio between the thickness of dampening plate 12 and saw blade 16 is configured to minimize the weight of dampening plate 12 while maintaining its rigidity and a profile streamlined enough to function with table saw 24 without contacting unintended portions thereof. In particular, the thickness of dampening plate 12 is practically held within a certain range in order to accommodate the length of arbor 18 to which the saw blade 16 and dampener 10 will be attached. Clearly, while there are standard arbor lengths, there are also variations thereof so that the thickness of dampening plate 12 could have a rather large range as a result of such variations. Nonetheless, it is preferred to minimize the weight of dampener 10 to reduce strain on the motor and so forth.

Shock absorbing ring 14, as noted above, abuts one side 38 of saw blade 16 when dampener 10 is installed along with saw blade 16 on arbor 18. Ring 14 serves to reduce the vibration caused by the saw motor, and thus prevents those vibrations from being translated to perimeter 40 of blade 16. In combination, ring 14 and dampening plate 12 vastly reduce the vibrations when blade 16 is in operation.

It will be appreciated that dampener 10 will function by using dampening plate 12 alone, as plate 12 substantially increases the rigidity of blade 16, and thereby reduces the deflections of blade 16. While the concavity of plate 12 allows for the spring bias force, as noted above when nut 20 is tightened, plate 12 may be flat on the side adjacent saw blade 16, or may take on any number of configurations allowing plate 12 to abut blade 16, although abutment adjacent perimeter 26 of plate 12 creates a greater stability than abutment closer to axis 36.

Dampening plate 12 may also have shapes other than circular, although it is advantageous for plate 12 to be weight balanced about axis 36, as noted above, in order to maintain proper balance for smooth operation. The configuration of recessed area 34 and the configuration of ring 14 may also vary. Each of area 34 and ring 14 may have shapes other than annular. Likewise, there could be a plurality of areas 34 and a plurality of rings 14, or instead of a ring, the shock absorber could be made in various pieces and various shapes, with corresponding recessed areas 34.

It will be further appreciated that dampener 10 may function without dampening plate 12 abutting saw blade 16 when installed. In that instance, ring 14 or a similar shock absorber would alone abut saw blade 16 and provide both the shock absorbing quality as well as increasing the stability of blade 16. Nonetheless, in the preferred embodiment, the abutment of plate 12 along with the abutment of ring 14 provides the greatest amount of stability and shock absorption to prevent the vibration of blade 16. Preferably, plate 12 is not tightened so much as to move blade 16 out of true.

Accordingly, the improved saw blade is simplified, provides an effective, safe, inexpensive, and efficient device which achieves all the enumerated advantages, provides for eliminating difficulties encountered with prior devices, and solves problems and obtains new results in the art.

In the foregoing description, certain terms have been used for brevity, clearness and understanding, but no unnecessary limitations are to be implied therefrom beyond the requirement of the prior art, because such terms are used for descriptive purposes and are intended to be broadly construed.

Moreover, the description and illustration of the invention is by way of example, and the scope of the invention is not limited to the exact details shown or described.

Having now described the features, discoveries and principles of the invention, the manner in which the improved saw blade is constructed and used, the characteristics of the construction, and the advantageous, new and useful results obtained; the new and useful structures, devices, elements, arrangements, parts and combinations are set forth in the appended claims.

1. A vibration dampener for a circular saw blade having a pair of sides, the dampener comprising:
a dampening plate having a first side; and
at least one shock absorber projecting outwardly from the side of the dampening plate.

2. The dampener as defined in claim 1 wherein at least a portion of the first side of the dampening plate is adapted to be disposed in abutment to one side of the saw blade.

3. The dampener as defined in claim 2 wherein the dampening plate has a perimeter and is adapted to abut the first side of the saw blade adjacent said perimeter.

4. The dampener as defined in claim 3 wherein the first side of the dampening plate defines a concavity.

5. The dampener as defined in claim 4 wherein the dampening plate is adapted to provide spring-bias force to press the dampening plate adjacent its perimeter against the saw blade when the dampening plate is installed with the saw blade.

6. The dampener as defined in claim 1 wherein the at least one shock absorber is adapted to be disposed between and abut each of the saw blade and the dampening plate.

7. The dampener as defined in claim 6 wherein the dampening plate defines at least one recessed area and the at least one shock absorber is disposed partially within the at least one recessed area.

8. The dampener as defined in claim 7 wherein the recessed area is annular and the at least one shock absorber is annular.

9. The dampener as defined in claim 7 wherein the at least one shock absorber is removably held within the recessed area.

10. The dampener as defined in claim 9 wherein the at least one shock absorber is held by an interference fit.

11. A vibration dampener for a circular saw blade, the dampener comprising:
a dampening plate having a first side with at least a portion of the first side adapted to be disposed in abutment to one side of the saw blade; the dampening plate having a transverse axis about which the plate is substantially radially weight-balanced.

12. The dampener as defined in claim 1 1 wherein the dampening plate and the saw blade have respective weights; and the ratio of the weight of the dampening plate to the weight of the saw blade has a range of 1:4 to 1:1.

13. The dampener as defined in claim 12 wherein the weight of the dampening plate has a range of 0.4 to 1.0 pounds.

14. The dampener as defined in claim 11 wherein the saw blade has a diameter and the dampening plate is substantially circular and has a diameter; and the ratio of the diameter of the dampening plate to the diameter of the saw blade has a range of 1:4 to 1:2.

15. The dampener as defined in claim 14 wherein the dampening plate has a diameter in the range of 3 to 5 inches.

16. The dampener as defined in claim 11 wherein the saw blade has a body having a thickness and the dampening plate has a thickness; and the ratio of the thickness of the dampening plate to the thickness of the saw blade is in the range of 4.5:1 to 1.7:1.

17. The dampener as defined in claim 16 wherein the thickness of the dampening plate is in the range of 0.100 to 0.375 inches.

18. A vibration dampener for a circular saw blade having a pair of sides, the dampener comprising:
a dampening plate having a first side at least a portion of the which is adapted to be disposed in abutment to one side of the saw blade; and
at least one shock absorber adapted to be disposed between and abutting each of the saw blade and the dampening plate.

19. The dampener as defined in claim 18 wherein the dampening plate has a perimeter and is adapted to abut said one side of the saw blade adjacent said perimeter.

20. The dampener as defined in claim 18 wherein the dampening plate defines at least one recessed area and the at least one shock absorber is disposed partially within the at least one recessed area.

21. The dampener as defined in claim 18 wherein the dampening plate has a transverse axis about which the dampening plate is substantially radially weight-balanced.

22. A saw comprising:
a frame having a work surface;
a circular saw blade rotatably connected to the frame, a portion of the saw blade extending above the work surface;
a drive mechanism to rotate the saw blade;
a dampener abutting and coaxially rotatable with the saw blade; and
the dampener disposed below the work surface.

23. The saw as defined in claim 22 wherein the dampener includes a dampening plate having a perimeter, the dampening plate abutting the saw blade adjacent said perimeter.

24. The saw as defined in claim 23 wherein the dampener includes at least one shock absorber disposed between and abutting each of the saw blade and the dampening plate.

25. The saw as defined in claim 24 wherein the dampening plate defines at least one recessed area and the at least one shock absorber is disposed partially within the at least one recessed area.

26. The saw as defined in claim 25 wherein the dampener has a central axis about which the dampener is substantially weight-balanced.
